(19) United States
(12) Patent Application Publication
(10) Pub. No.: US 2011/0058039 A1
(43) Pub. Date: Mar. 10, 2011

(54) SECURITY SYSTEM FOR USE IN HIRED VEHICLES

(75) Inventor: Thomas John, New Hyde Park, NY (US)

(73) Assignee: American Gardens Management Co., New Hyde Park, NY (US)

(21) Appl. No.: 12/859,044

(22) Filed: Aug. 18, 2010

Related U.S. Application Data
(60) Provisional application No. 61/239,905, filed on Sep. 4, 2009.

(51) Int. Cl. H04N 7/18

(52) U.S. Cl. 348/148; 348/E07.085

(57) ABSTRACT

In accordance with one embodiment, a security system is provided on the vehicle that captures and stores the image (face) of the customer but also documents, using a GPS system, the entry (start) point and the exit (end) point of the ride. All this information can be stored locally and transmitted wirelessly to a remote central database where it is stored and can later be accessed.

### CROSS-REFERENCE TO RELATED APPLICATIONS

The present application claims the benefit of U.S. patent application Ser. No. 61/239,905, filed Sep. 4, 2009 which is hereby incorporated by reference in its entirety.

### TECHNICAL FIELD

The present invention relates to security systems and in particular, the present invention relates to a photographic based security system that is intended for use with hired vehicles to document the identity of each occupant thereof.

### BACKGROUND

Hired vehicles, including cabs and livery cars, are very common in cities. There is an inherent danger for the drivers of these vehicles since they open their doors to strangers for each fare every day. For example, hired drivers are the target of robberies and unfortunately, these robberies can escalate to more serious crimes including aggravated assault or even murder. In recent days in New York City there has been a wave of murders of hired drivers which has caused fear in the driver community and this industry.

While there are some safety measures being taken to protect the drivers, these measures for the most part offer some help but each has its own deficiencies. For example, bullet proof glass can be employed in the vehicle and other measures can be taken.

Thus, there is a need for providing an alternative security system for protecting the drivers of hired vehicles.

### SUMMARY

In accordance with one embodiment, a security system is provided on the vehicle that captures and stores the image (face) of the customer but also documents, using a GPS system, the entry (start) point and the exit (end) point of the ride. All this information can be stored locally and transmitted wirelessly to a remote central database where it is stored and can later be accessed.

These and other aspects, features and advantages shall be apparent from the accompanying Drawings and description of certain embodiments of the invention.

### BRIEF DESCRIPTION OF THE DRAWINGS

FIG. 1 is a schematic view of a security system in accordance with the present invention;

FIG. 2 is a side view of a vehicle including a security camera that is part of the system of FIG. 1; and

FIG. 3 is a perspective view of the vehicle with the security system of the present invention.

### DETAILED DESCRIPTION OF CERTAIN EMBODIMENTS OF THE INVENTION

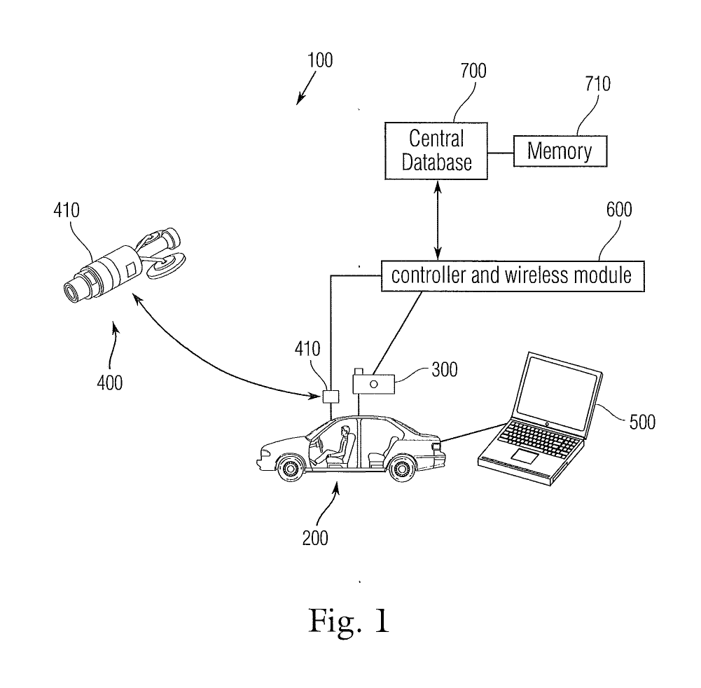

In accordance with one embodiment of the present invention, a security system 100 for use in a hired vehicle 200, such as a cab or livery vehicle, etc., is shown in FIGS. 1-3. The security system 100 includes a number of components some of which are on-board the vehicle 200 and some of which are off-board the vehicle 200.

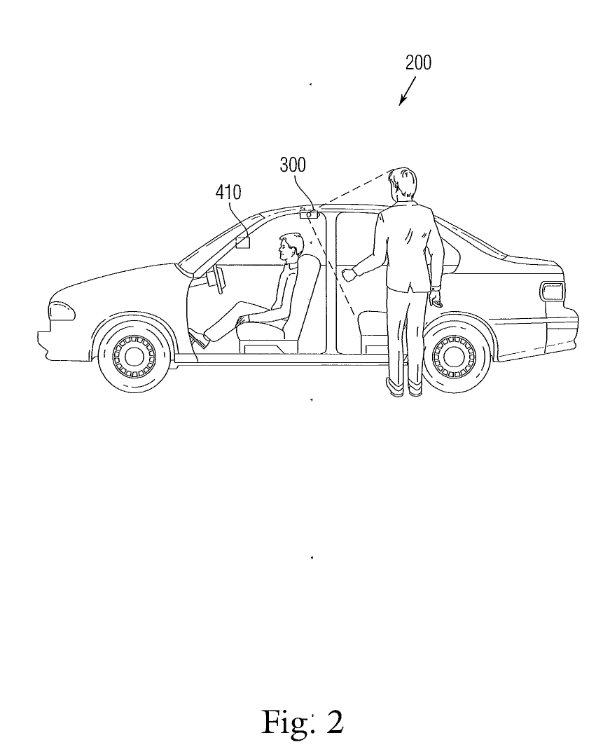

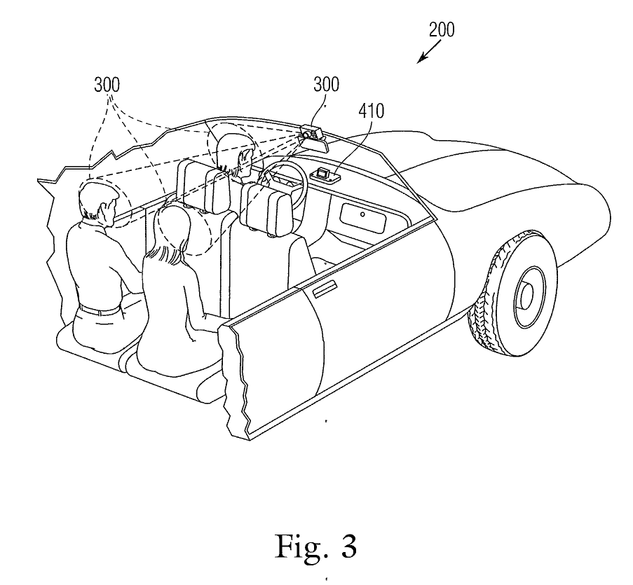

In particular, the vehicle 200 is mounted with a camera unit or recording device 300 or the like that is configured to capture and record (store) an image of a customer who has hired the vehicle 200 for a fare. The camera unit 300 can be mounted in any number of different locations including exterior locations on the driver's side of the vehicle so as to record the image of the customer as the customer is gaining access to the backseat of the vehicle or the camera unit 300 can be located internally within the vehicle 200 (e.g., mounted on the dash board or along the inner side beam between the front seats and the backseats. FIG. 2 shows the camera unit 300 located along the exterior of the vehicle 200, while FIG. 3 shows the camera unit 300 located within the interior of the vehicle 200 in several different possible locations.

The system 100 The camera unit 300 can be any number of different types of camera devices (e.g., CCD camera) so long as they are capable of taking a picture (image) and storing the taken image. The camera unit 300 can be movable by the driver; however, it typically should be mounted at a location that captures the image (face) of the customer regardless of the physical characteristics (height) of the customer, etc.

The camera unit 300 is in communication (wired or wireless) with a local controller and wireless module 600. The controller 600 includes local memory that can store the images taken by the camera unit 300 and the controller 600 is also designed to allow the driver to manually capture the image of the customer or, as described below, the controller 600 can be configured to automatically capture the customer's image upon the occurrence of an event.

The controller 600 can also be configured so that when either of the back doors is opened, the camera unit 300 automatically takes an image depending upon which door opens. The system would therefore include sensors that are operatively positioned within the hardware of the door so that opening of the door is detected. The sensors communicate such event to the controller 600 which then instructs the camera 300 to operate and capture an image of the customer either entering the vehicle or sitting in the backseat.

Another event that can cause the camera unit 300 to be operated to capture the image is the driver pressing the “fare hired” button which causes the fare meter to start running. This will likely cause the customer's image to be captured when the customer is sitting in the backseat.

Thus, the vehicle can have one or more cameras that can be used to capture the image of the occupant upon the occurrence of a predetermined event.

The system 100 also includes an on-board GPS system 400 that includes a GPS unit (receiver) 410 that is located within the vehicle 200. The GPS unit 410 is in communication with a GPS satellite 420 that serves, as is know, to track the movements of the vehicle 200 (GPS provides reliable positioning, navigation, and timing services to worldwide users on a continuous basis in all weather, day and night, anywhere on or near the Earth).

The GPS unit 410 communicates with the controller 600 to allow positioning data to be captured and stored in the local memory. For example, each time a fare is hired and a customer enters the vehicle 200, the date, time, and starting location for the ride is captured and stored in memory associated with controller 600. Also, when the trip is completed (e.g., as evidenced by the “fare off” button being pressed, the positioning data and time and date data are captured. In other words, an information portfolio is built for each customer that includes the image of the customer, the date and time and location of where the customer entered (start point of the trip) and the date and time and location of where the customer exited (end point of the trip).

While all this information including the image of each customer can be stored locally at controller/module 600, the controller 600 includes a wireless communications module and therefore can wirelessly send and receive data from other remote devices. In particular, the controller 600 communicates with a central database 700 that includes memory 710. In this manner, all of the customer information (image and GPS data) is also stored remotely in memory 710.

The GPS data can be gathered automatically. For example, when the hired on button is pressed and then when the button is pressed to stop the fare, GPS positioning information can be gathered for each event. The driver can gather the information in other ways as well.

The vehicle 200 can also include an on-board computer, dash display and keyboard 500. The on-board computer 500 can be used for a number of different reasons including data entry as well as providing a communication link. It will be appreciated that the on-board computer 500 can include a wireless communication device or module that can wirelessly communicate via a network (internet) to another device, such as a server or the like. In particular, the on-board computer 500 communicates with the controller 600 and therefore, data, such as notes, etc., inputted into the computer 500 can be likewise communicated to the central database (server) 700 and stored in memory 710.

Decals and the like can be displayed on the window of the vehicle 200 alerting customers that their image will be captured. The system 100 thus offers a simple deterrent for the ongoing violence and danger facing drivers of hired vehicles since word will spread that the vehicles 200 are so equipped and even at the point (location) of the potential crime, an individual who is inclined to commit a crime may decide otherwise due to the fear that his or her image will be captured and other identifying information will be gathered concerning the customer.

It will be appreciated that both the local and central database can be configured in any number of different ways as to how the information is categorized and stored. For example, fares (customers) for each day can be given a consecutive identifying number (e.g., [cust001]) that is used as a customer identifier and under which the other information, including the captured image and GPS information, is stored.

Since the entire process can be automatically instituted as by either the opening of the car door or by pressing the “hired on” button, the system 100 is easy and does not require the active participation of the driver. Instead it is simply integrated into existing hardware/devices present in the vehicle 200.

In the unfortunate event that there is an incident, the records stored in memory 710 (or the local memory) can be accessed and the authorities will be able to view the image of the customer and view other information concerning the event.

In accordance with the present invention and in contrast to other conventional photo systems, in the present system, the passenger's action causes the camera to activate and therefore, the system is a passive system. In other systems, the camera is activated by the user or operator (here the cab driver).

It will also be appreciated that other embodiments and other means for activating the camera are within the scope of the present invention. For example, the handle of the door can have a switch such that when the door handle is lifted or pressed or otherwise manipulated to open the door, the camera unit 300 is activated and a picture of the passenger is taken before the passenger enters the vehicle. There can also be a delay that is incorporated into the activation of the camera unit 300 and in particular, the camera unit 300 can be designed so that the image of the passenger is not taken until the passenger enters and sits in the backseat of the cab. The delay is of a sufficient time to permit a passenger to enter and sit in the backseat.

In yet another aspect, the controller is configured to aim the camera at a target location of the backseat based on which sensor sent the control signal. For example, if the back passenger door is opened, the camera unit 300 that is associated with this door is actuated or in the event of a central internal camera unit, the camera unit is aimed at the backseat portion closest to the back passenger door. Similarly, if the back driver door is opened, the camera unit 300 that is associated with this door is actuated or in the event of a central internal camera unit, the camera unit is aimed at the backseat portion closest to the back driver door.

It will also be appreciated that the present system is designed so that a packet of information is sent to the server—e.g., the packet of info can include the digital image, the date, time, GPS info—pickup location, drop off location, etc.

While the invention has been described in connection with certain embodiments thereof, the invention is capable of being practiced in other forms and using other materials and structures. Accordingly, the invention is defined by the recitations in the claims appended hereto and equivalents thereof.

What is claimed is:

1. A security system for a hired vehicle comprising:
a camera unit that has a camera for taking an image of a passenger's face;
a controller that is operatively connected to the camera unit;
a sensor that is associated with a door of the vehicle such that when the door is opened, a control signal is sent to the controller which causes the camera unit to take an image of the passenger's face; and
memory that is associated with a remote server that is in wireless communication with the controller and receives identification information from the controller including at least a date and time of pickup of the passenger and an image of a passenger.

2. The security system of claim 1, further including a GPS unit that is in communication with the controller to permit a location of the pickup to be determined and stored in memory as part of the identification information and a location of a drop off of the passenger to be determined and stored in memory as part of the identification information.
